(19) United States
(12) Patent Application Publication
(10) Pub. No.: US 2023/0369814 A1
(43) Pub. Date: Nov. 16, 2023

(54) Single Pair Ethernet Connector with Ratcheting Strain Relief Clip

(71) Applicant: Panduit Corp., Tinley Park, IL (US)

(72) Inventor: Roman J. Churnovic, Joliet, IL (US)

(73) Assignee: Panduit Corp., Tinley Park, IL (US)

(21) Appl. No.: 17/742,754

(22) Filed: May 12, 2022

(51) Int. Cl. H01R 24/64; H01R 13/58

(52) U.S. Cl. CPC H01R 24/64; H01R 13/5812; H01R 2201/04

(57) ABSTRACT

A communication connector comprising has a cover body with an opening and a strain relief clip. The strain relief clip has an opening configured to accept a communications cable The strain relief clip is also configured to be partially inserted into the opening. The strain relief clip has a plurality of grip arms configured to extend into the opening and surround an inserted cable and further configured to interact with an inside wall of the cover body such that rotation of the strain relief clip relative to the cover body causes the grip arms to press against the inserted cable.

### CROSS REFERENCE TO RELATED APPLICATIONS

This application claims benefit to U.S. Provisional Patent Application No. 63/309,025, filed on Feb. 11, 2022, the entirety of which is hereby incorporated by reference herein.

### FIELD OF THE INVENTION

The present invention relates generally to communications connectors and more specifically to communications connectors with a ratcheting strain relief clip.

### BACKGROUND

Currently the market offers a Single Pair Ethernet Shielded Plug Connector. The connector provides a small form factor design that is simple and inexpensive to manufacture, as well as quickly and easily terminated and unterminated by an installer without complex and expensive tools. The design provides the necessary retention forces on the individual wire conductors terminated to the IDCs, but lacks significant retention of the outer cable jacket which can create a negative perception from the customer. The latch used to remove the plug from a fixed connector is small and can be problematic in high density applications.

### SUMMARY

A communication connector comprising has a cover body with an opening and a strain relief clip. The strain relief clip has an opening configured to accept a communications cable The strain relief clip is also configured to be partially inserted into the opening. The strain relief clip has a plurality of grip arms configured to extend into the opening and surround an inserted cable and further configured to interact with an inside wall of the cover body such that rotation of the strain relief clip relative to the cover body causes the grip arms to press against the inserted cable.

### BRIEF DESCRIPTION OF THE FIGURES

FIG. 1 is an isometric view of a communications system.

FIG. 2 shows an isometric view of a first embodiment of a single pair ethernet plug assembly.

FIG. 3 is an exploded view of the single pair ethernet plug assembly of FIG. 2.

FIG. 4 is a section view of the communications system of FIG. 1 as taken from FIG. 1.

FIG. 5 is a section view of the communications system of FIG. 1 as shown in FIG. 4 with a tangle free plug latch in an unmated position relative to the SPE coupler assembly.

FIG. 6 is a rotated exploded view of the single pair ethernet plug assembly of FIG. 2.

FIG. 7 is an isometric exploded view of the cover assembly for the single pair ethernet plug assembly of FIG. 2.

FIG. 8 is a rear view of the cover assembly of FIG. 7.

FIG. 9 is a rear view of the cover assembly of FIG. 7.

FIG. 10 is a rear view of the cover assembly of FIG. 7.

FIG. 11 is a rear view of cover assembly of FIG. 7.

FIG. 12 is a rear view of cover assembly of FIG. 7.

FIG. 13 is an isometric view of communications system.

FIG. 14 shows an isometric view of a second of a single pair ethernet plug assembly.

FIG. 15 is an exploded view of a single pair ethernet plug assembly.

FIG. 16 is an exploded view of the cover assembly of the single pair ethernet assembly of FIG. 14.

FIG. 17 is another exploded view of the cover assembly of the single pair ethernet assembly of FIG. 14.

FIG. 18 is a third exploded view of the cover assembly of the single pair ethernet assembly of FIG. 14.

FIG. 19 is a rear isometric view of the cover assembly of the single pair ethernet assembly of FIG. 14.

FIG. 20 is another rear isometric view of the cover assembly of the single pair ethernet assembly of FIG. 14.

### DESCRIPTION OF THE INVENTION

The present invention is a shielded single pair ethernet plug with ratcheting cable strain relief and an extended tangle free latch.

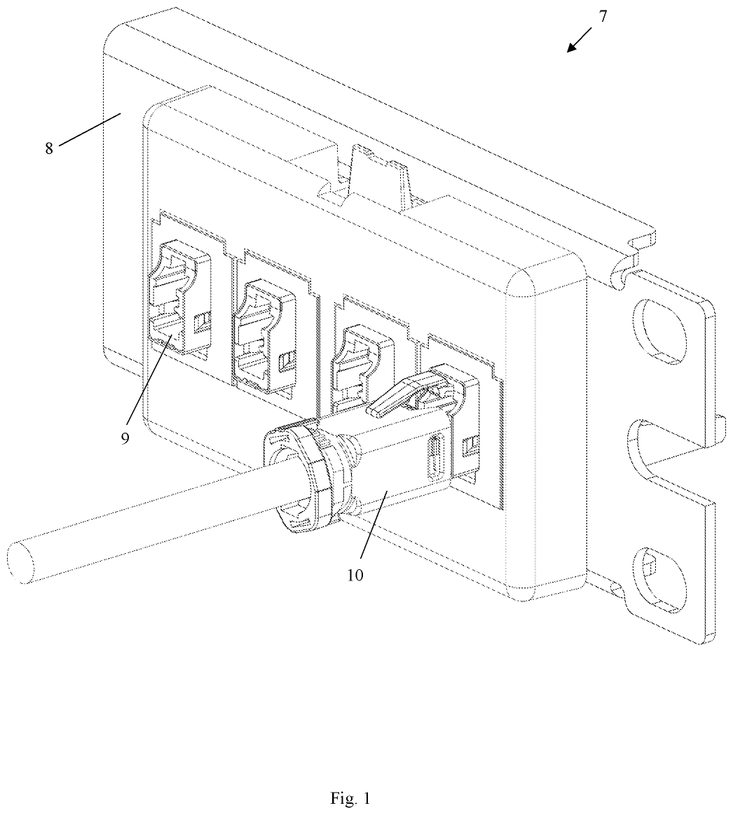

FIG. 1 is an isometric view of communications system 7 which includes patch panel 8, SPE coupler assemblies 9, and a first embodiment of a single pair ethernet plug assembly, single pair plug assembly 10.

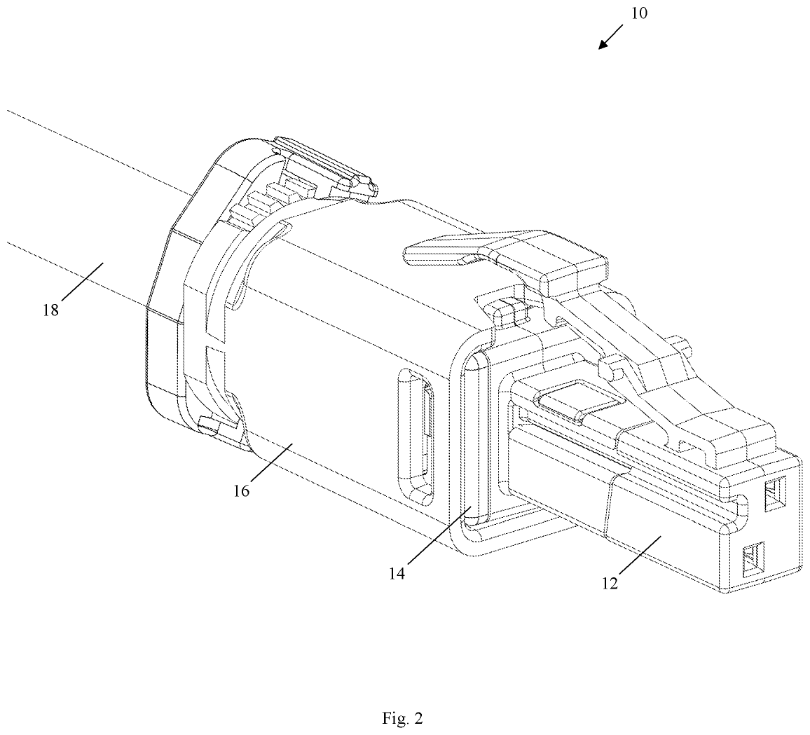

FIG. 2 shows an isometric view of single pair ethernet plug assembly 10 which includes main plug assembly 12, wire cap 14, cover assembly 16, and single pair ethernet cable 18.

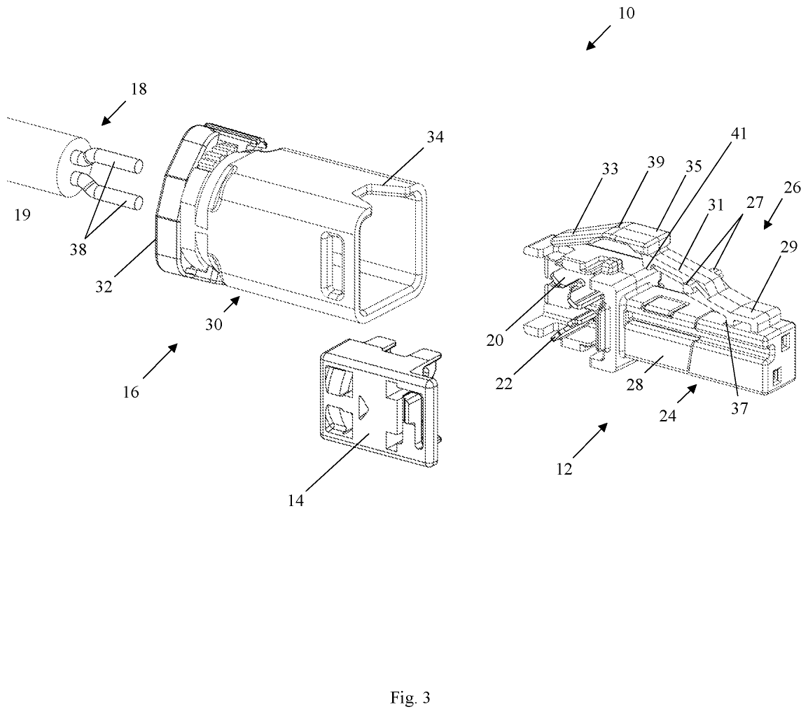

FIG. 3 is an exploded view of single pair ethernet plug assembly 10. Main plug assembly 12 includes upper contact 20, lower contact 22, main plug body 24, and shield wrap 28. Cover assembly 16 includes die cast cover 30 and ratcheting strain relief clip 32.

Pad 35 of tangle free plug latch 26 on main plug body 24 of main plug assembly 12 provides users with a larger surface area for latch depression than the previous design. Keying feature 34 on die cast cover 30 is now an open slot which allows for larger downward travel for tangle free plug latch 26. Tangle free plug latch 26 is designed to prevent a large gap between tangle free plug latch 26 and die cast cover 30 of cover assembly 16 when single pair ethernet plug assembly 10 is fully assembled. Tangle free plug latch 26 is designed to prevent terminated cabling from becoming entwined with each other; either when in a box prior to installation, or when trying to remove the cable from a switch configuration after installation.

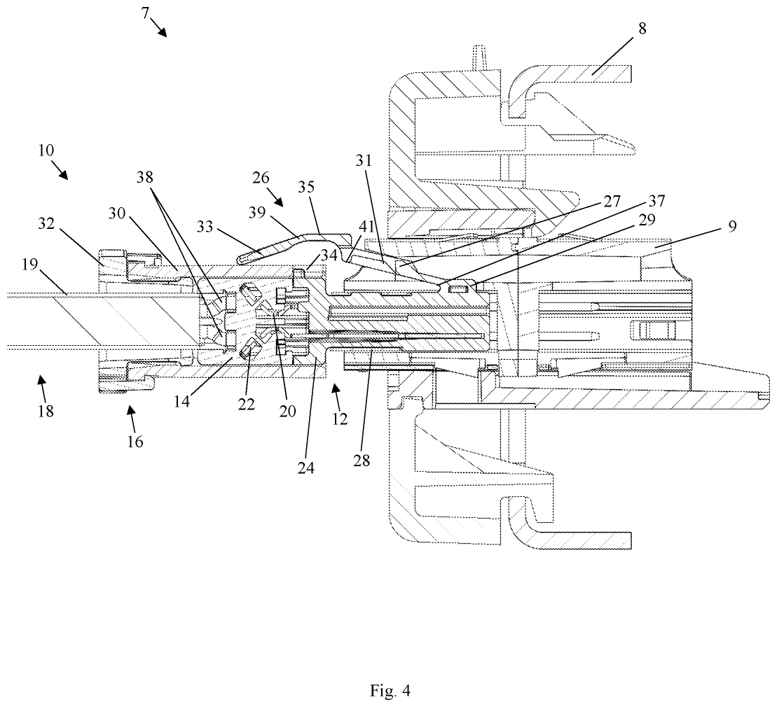

FIG. 4 is a section view of communications system 7 as taken from FIG. 1 about the edge of the catch feature 27 of tangle free plug latch 26. Tangle free plug latch 26 is shown in a mated position relative to SPE coupler assembly 9. Tangle free plug latch 26 includes fixed end 29, movable arm 31, and free end 33. Fixed end 29 of tangle free plug latch 26 is integrally connected to main plug body 24 of main plug assembly 12. Catch feature 27 on movable arm 31 of tangle free plug latch 26 is designed to engage with any fixed connector designed with an IEC 63171-1 SPE interface to lock single pair ethernet plug assembly 10 into a mated position. When single pair ethernet plug assembly 10 is fully assembled; free end 33 of tangle free plug latch 26 angles downward toward die cast cover 30 of cover assembly 16 to close an otherwise open gap that could allow for items to become entangled with movable arm 31. Entanglement could cause damage to functionality or delays in the installation process.

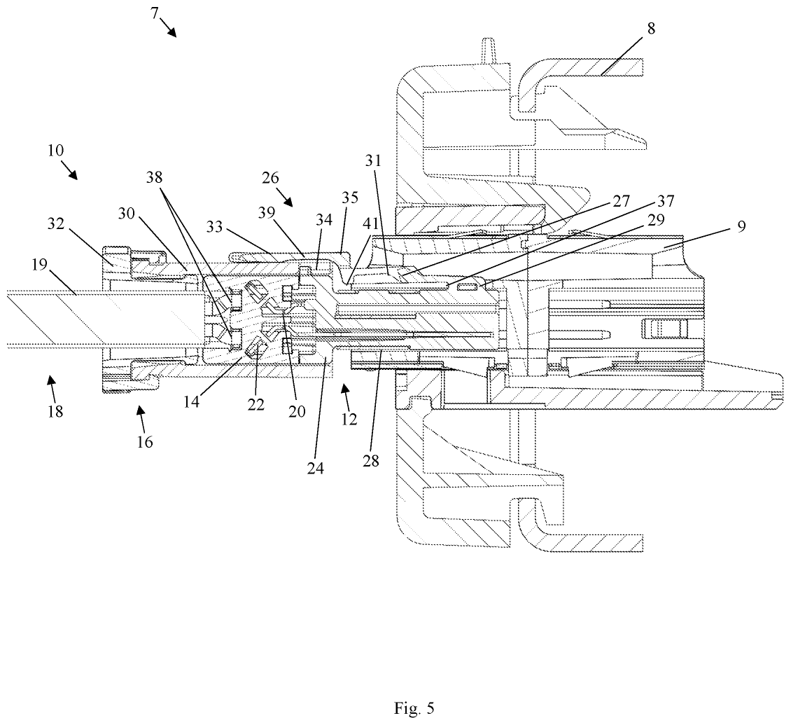

FIG. 5 is a section view of communications system 7 as shown in FIG. 4 with tangle free plug latch 26 in an unmated position relative to SPE coupler assembly 9. When pad 35 is pressed downward, movable arm 31 rotates about radiused edge 37 of fixed end 29 to release catch feature 27 on tangle free plug latch 26 from the mated position. Thin web 39 on free end 33 allows for free end 33 to ride along the top of die cast cover 30 without causing any material yielding to occur on tangle free plug latch 26. This means that when pad 35 is released and movable arm 31 returns to a neutral position; free end 33 of tangle free plug latch 26 will also return to its original position, providing continued tangle prevention throughout a plurality of mating cycles. Keying feature 34 on die cast cover 30 of cover assembly 16 allows for tangle free latch 26 to travel beyond the necessary depth to disengage catch feature 27 from the mating interface. Stop face 41 prevents overtravel of movable arm 31 and free end 33 of tangle free plug latch 26 ensuring material yielding does not occur.

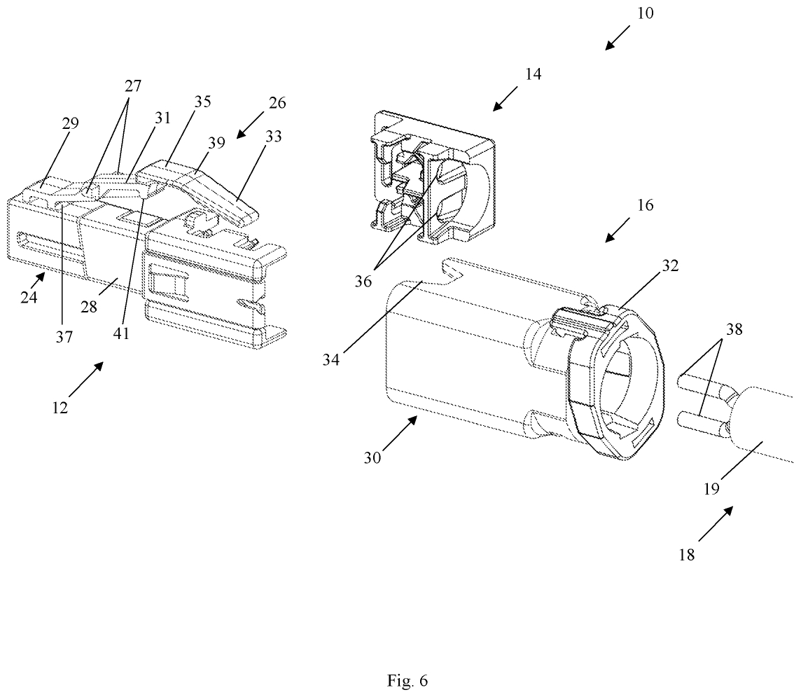

FIG. 6 is a rotated exploded view of single pair ethernet plug assembly 10. Conductor slots 36 on wire cap 14 are now centrally aligned to make it easier for conductors 38 of single pair ethernet cable 18 to be routed into place. This allows single pair ethernet cable 18 to maintain a central alignment to die cast cover 30 when terminating and finalizing assembly of single pair ethernet plug assembly 10.

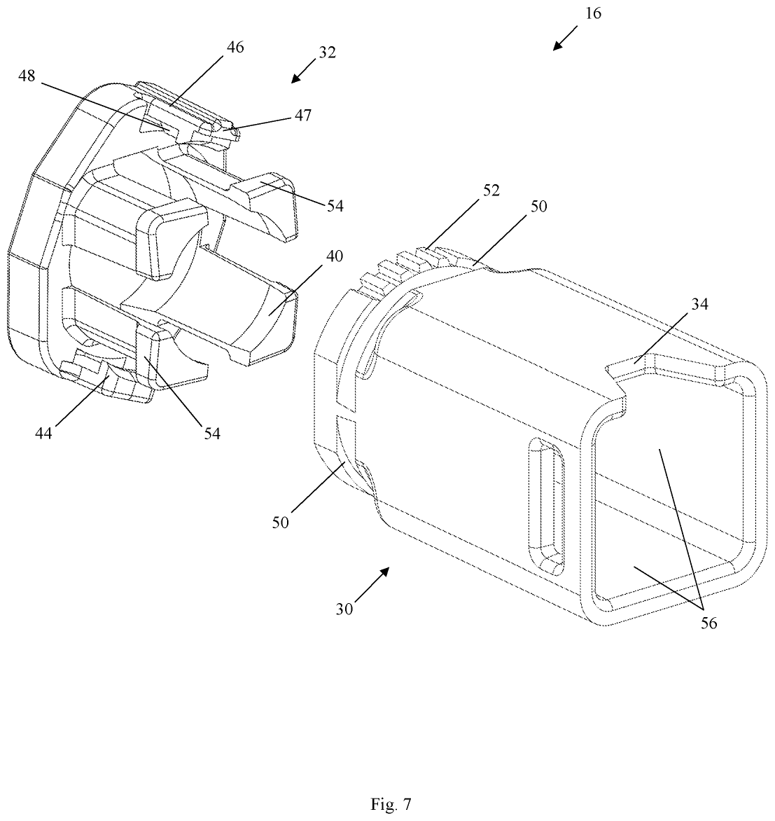

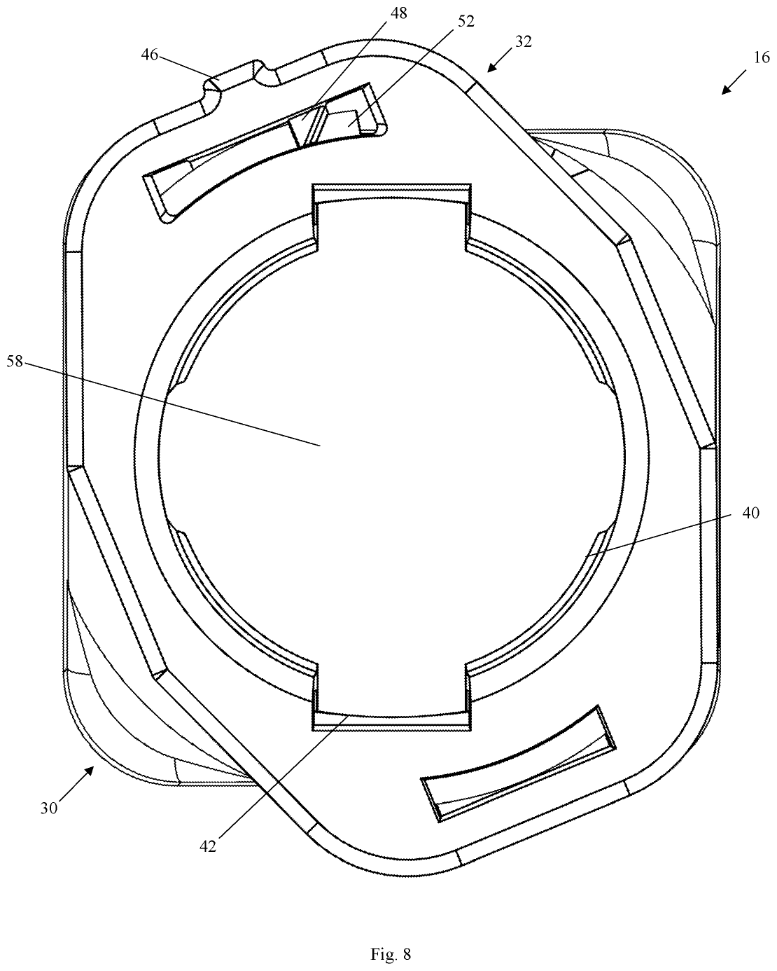

FIG. 7 is an isometric exploded view of cover assembly 16 which includes die cast cover 30 and ratcheting strain relief clip 32. Grip arms 40 on ratcheting strain relief clip 32 are inserted into rear opening 42 (FIG. 8-12) of die cast cover 30. Latch 44 and ratchet latch 46 on ratcheting strain relief clip 32 are snapped onto catch ledge 50 of die cast cover 30 to secure ratcheting strain relief clip 32 to die cast cover 30 and complete cover assembly 16. As ratcheting strain relief clip 32 is rotated clockwise axially about die cast cover 30, rotational latch 48 on ratchet latch 46 of ratcheting strain relief clip 32 snaps on rotational catch teeth 52 of die cast cover 30 to prevent counterclockwise rotation.

When ratcheting strain relief clip 32 is rotated clockwise about die cast cover 30, outer surfaces 54 on grip arms 40 of ratcheting strain relief clip 32 press against inner walls 56 of die cast cover 30, which causes grip arms 40 to bend inward and through hole 58 of cover assembly 16 to become smaller. As the diameter of through hole 58 decreases, it will provide strain relief to cable jacket 19 of single pair ethernet cable 18. Rotational catch teeth 52 of die cast cover 30 are arranged to secure ratcheting strain relief clip 32 in one of five even increments from zero to forty-five degrees depending on the outer diameter of single pair ethernet cable 18. Ratchet latch 46 on ratcheting strain relief clip 32 and rotational catch teeth 52 on die cast cover 30 are designed such that the overall width of single pair ethernet plug assembly 10 will remain constant throughout the rotation of ratcheting strain relief clip 32. Tab 47 on ratchet latch 46 can be used to lift rotational latch 48 on rachet latch 46 over rotational catch teeth 52 of die cast cover 30 to allow a user to rotate ratcheting strain relief clip 32 counterclockwise. This would release the grip on single pair ethernet cable 18 and allow a user to re-terminate the cable multiple times should the need arise.

FIG. 8 is a rear view of cover assembly 16 with ratcheting strain relief clip 32 at 0° rotation.

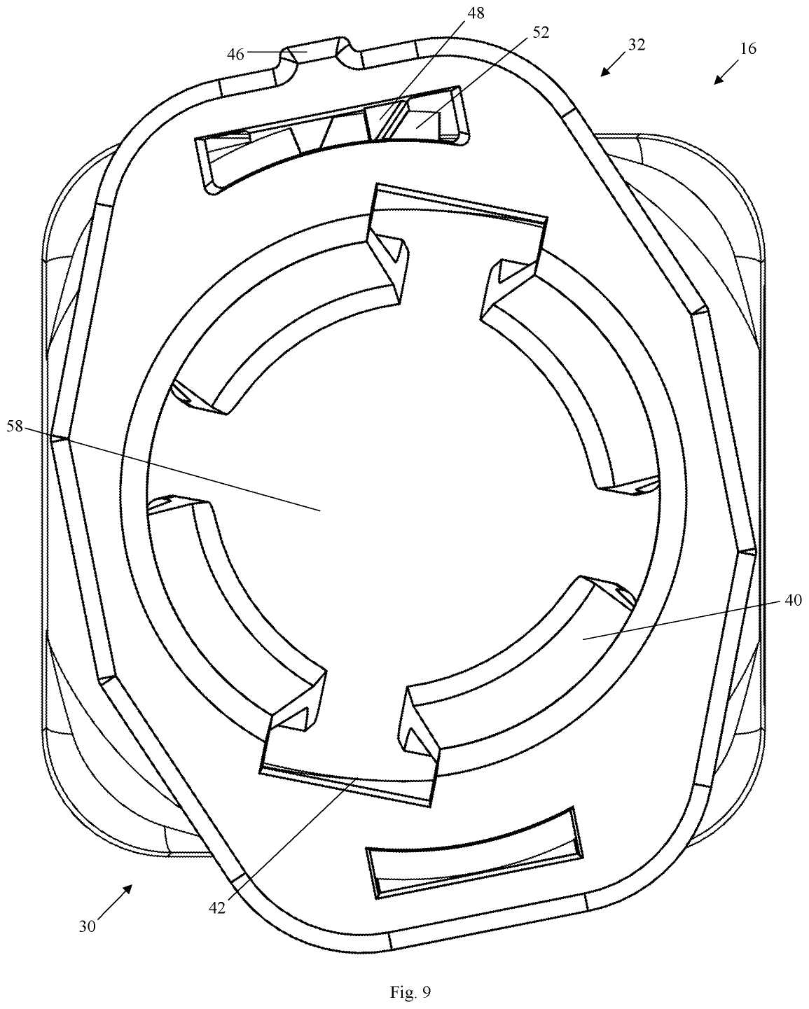

FIG. 9 is a rear view of cover assembly 16 with ratcheting strain relief clip 32 at 11.25° rotation.

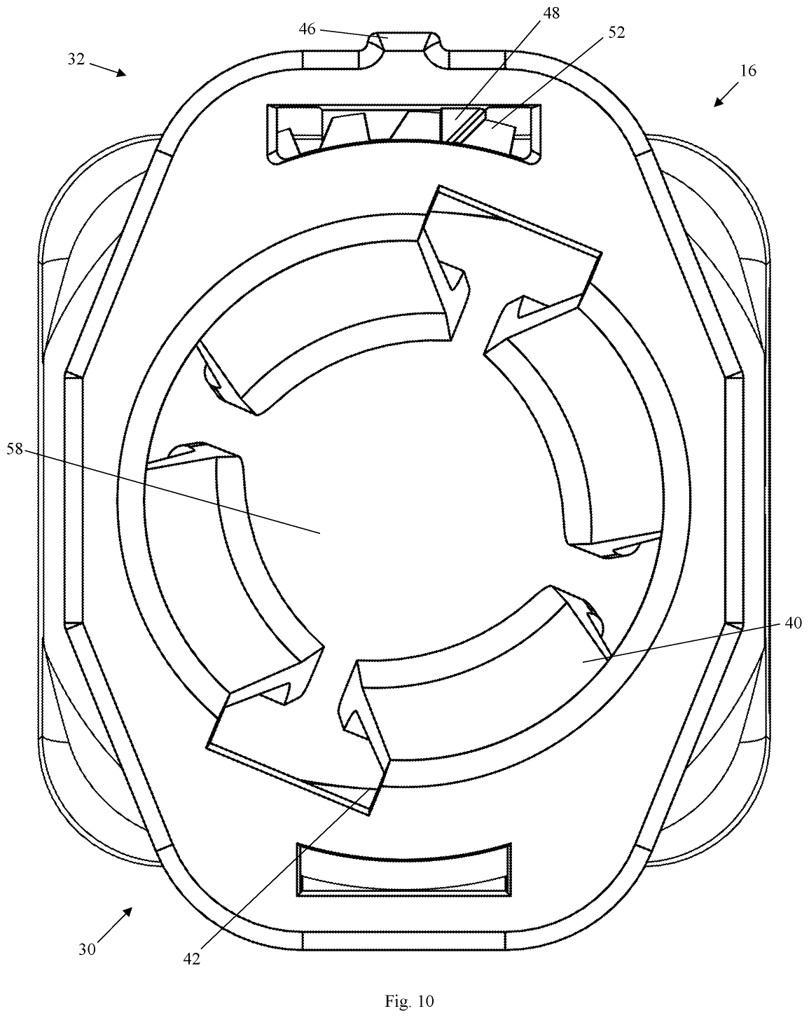

FIG. 10 is a rear view of cover assembly 16 with ratcheting strain relief clip 32 at 22.5° rotation.

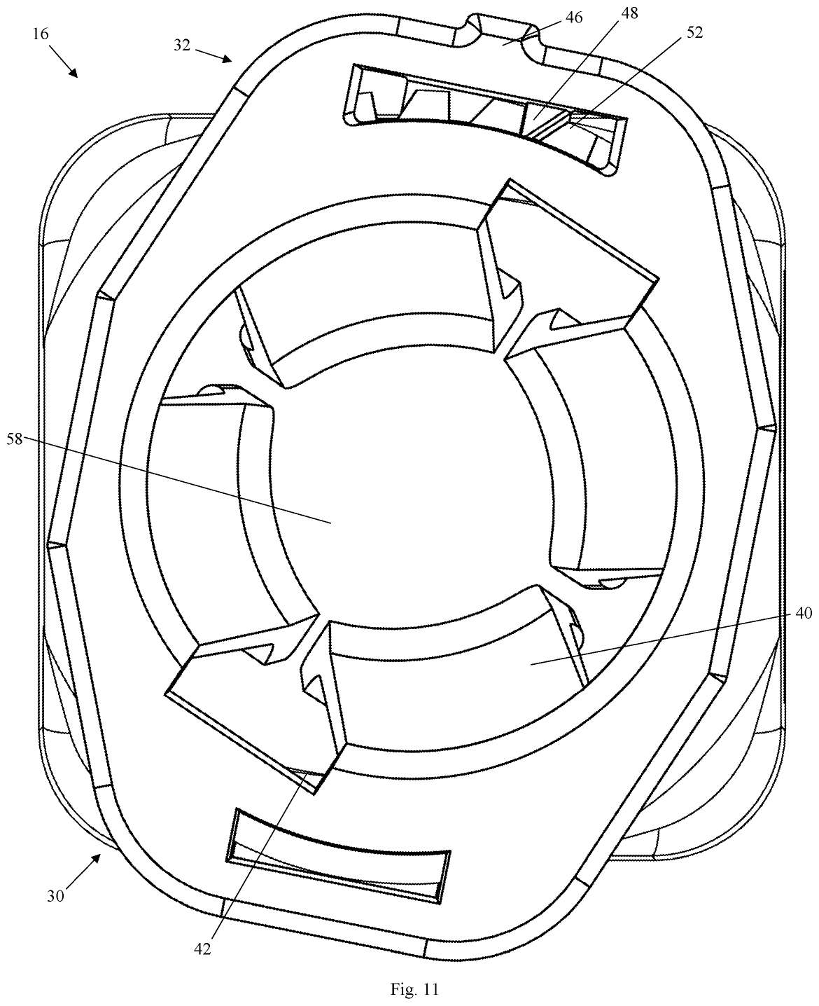

FIG. 11 is a rear view of cover assembly 16 with ratcheting strain relief clip 32 at 33.75° rotation.

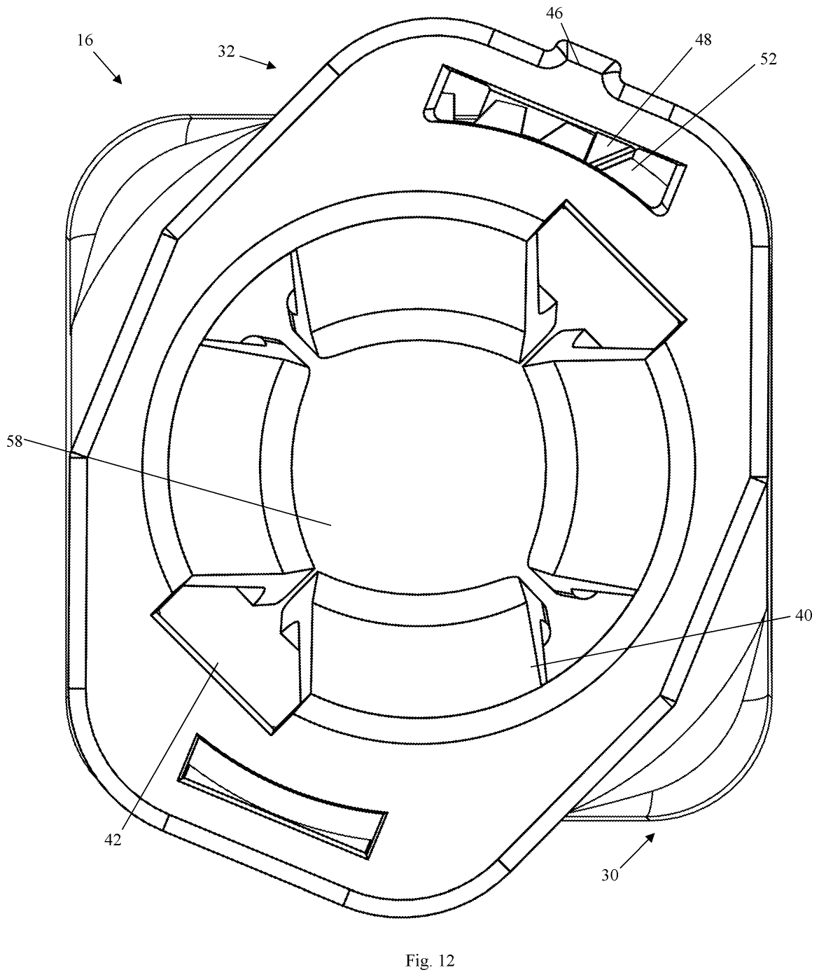

FIG. 12 is a rear view of cover assembly 16 with ratcheting strain relief clip 32 at 45° rotation.

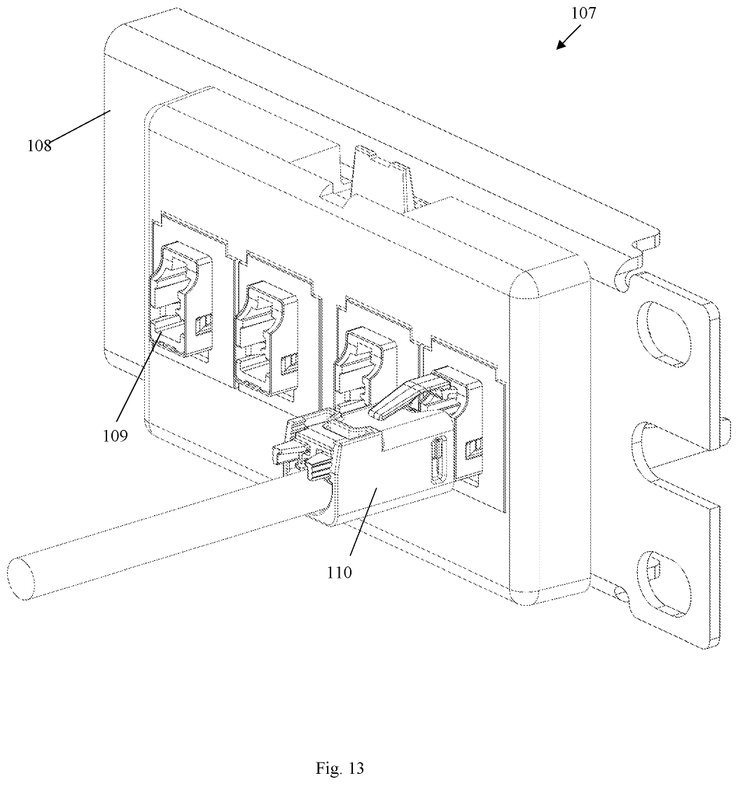

FIG. 13 is an isometric view of communications system 107 which includes patch panel 108, SPE coupler assemblies 109, and a second embodiment of a single pair ethernet plug assembly, single pair ethernet plug assembly 110.

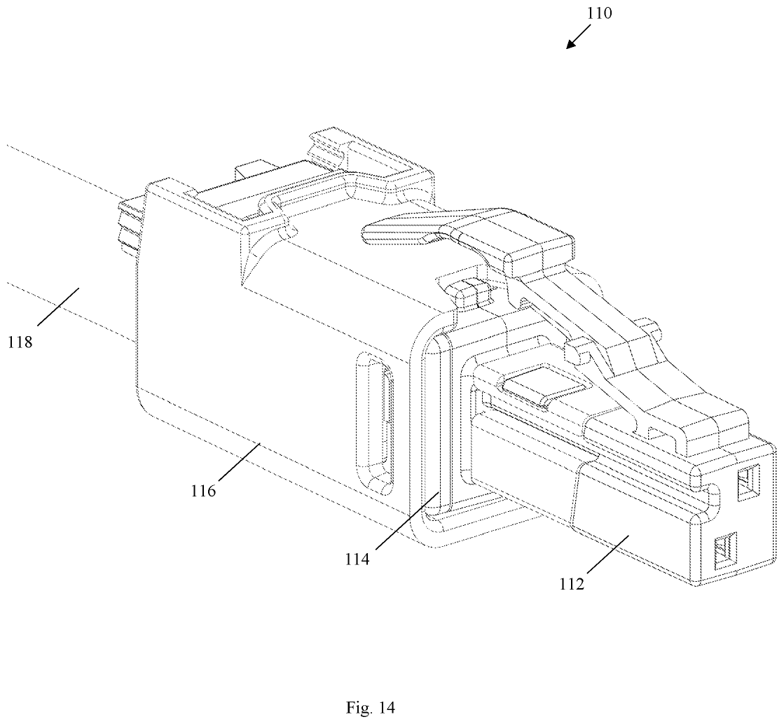

FIG. 14 shows an isometric view of single pair ethernet plug assembly 110 which includes main plug assembly 112, wire cap 114, cover assembly 116, and single pair ethernet cable 118.

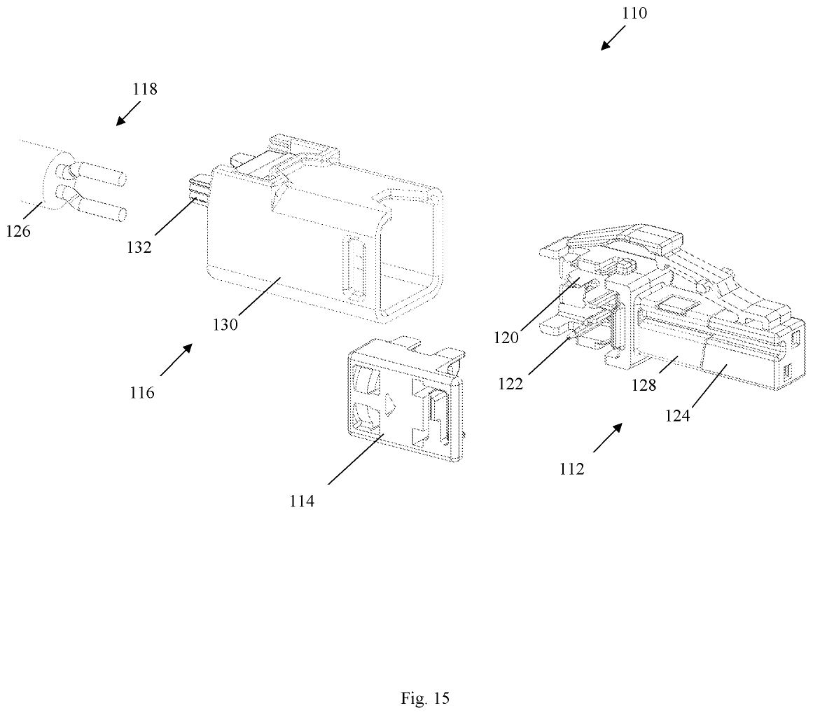

FIG. 15 is an exploded view of single pair ethernet plug assembly 110. Main plug assembly 112 includes upper contact 120, lower contact 122, main plug body 124, and shield wrap 128. Cover assembly 116 includes die cast cover 130 and strain relief clip 132.

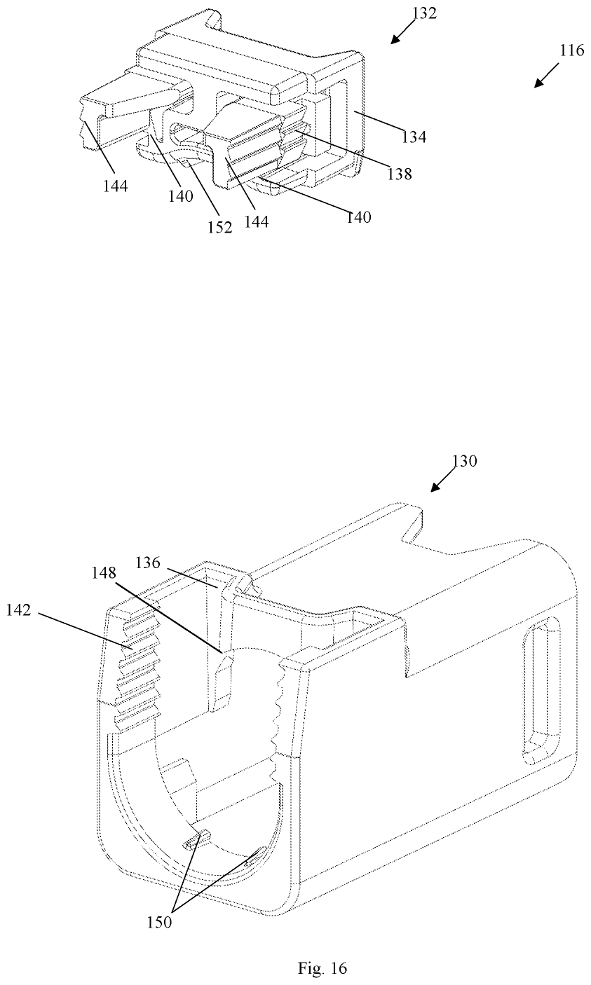

FIG. 16 is an exploded view of cover assembly 116 which includes die cast cover 130 and strain relief clip 132.

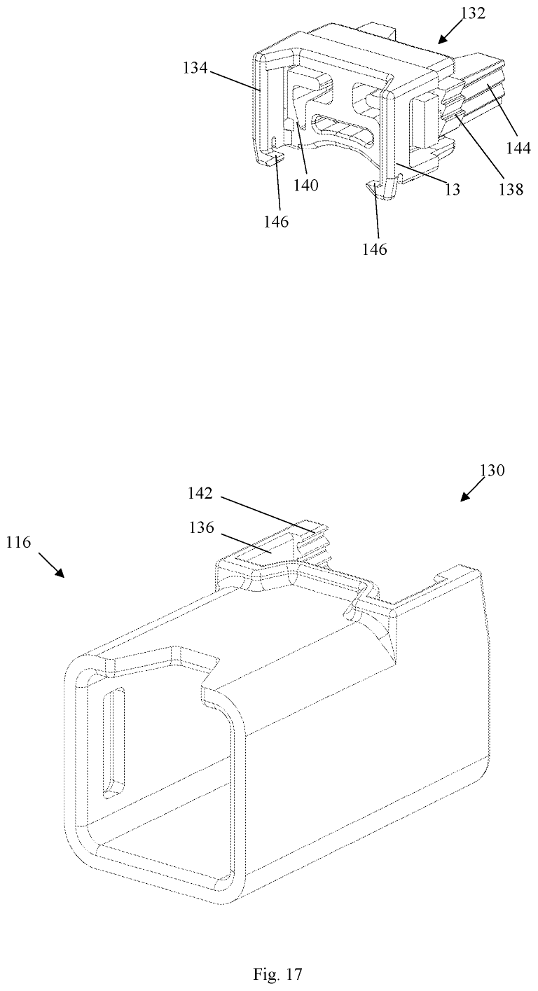

FIG. 17 is an exploded view of cover assembly 116 rotated 180-degrees about a vertical axis from FIG. 4.

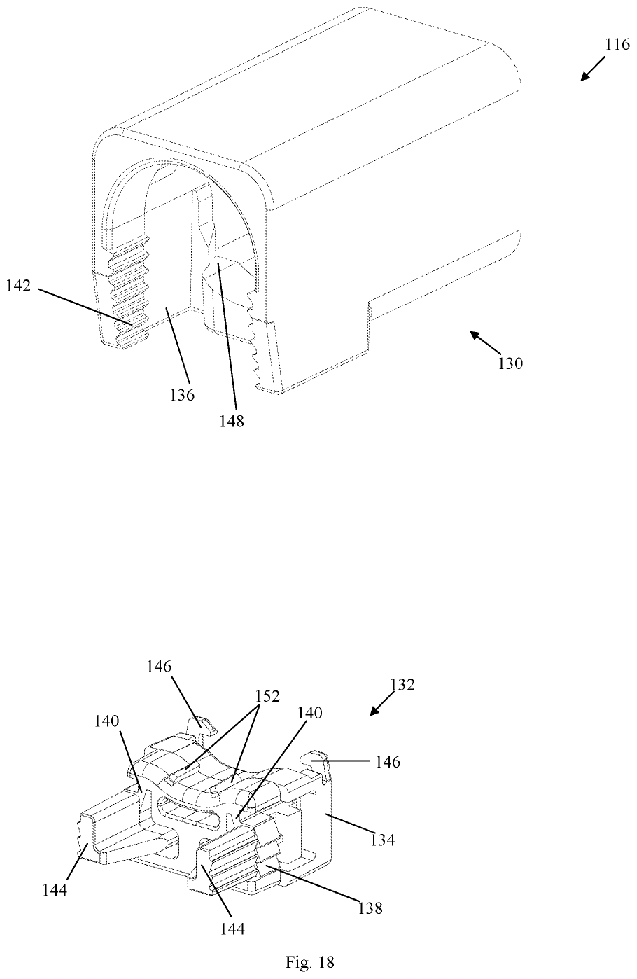

FIG. 18 is an exploded view of cover assembly 116 rotated 180-degrees about a horizontal axis from FIG. 5.

Strain relief clip 132 is designed to lock into die cast cover 130 and create a clamping force on outer jacket 126 of single pair ethernet cable 118. Support legs 134 on strain relief clip 132 fit into channels 136 of die cast cover 130. Teeth 138 on flex arms 140 of strain relief clip 132 engage with fixed teeth 142 on die cast cover 130. As strain relief clip 132 is pressed downward onto outer jacket 126 of single pair ethernet cable 118, flex arms 140 will rotate inward to allow strain relief clip 132 to compress around single pair ethernet cable 118. When the force is released from strain relief clip 132, flex arms 140 will open outward and teeth 138 will engage fixed teeth 142 on die cast cover 130 and prevent any additional upward movement of strain relief clip 132. This will effectively compress and hold outer jacket 126 of single pair ethernet cable 118 when in use. Barbs 150 on die cast cover 130 and barbs 152 on strain relief clip 132 are designed to cut into outer jacket 126 of single pair ethernet cable 118 when strain relief clip 132 is in its final locked position to provide more robust cable retention.

Release arms 144 on flex arms 140 of strain relief clip 132 can be pressed inward to disengage teeth 138 from fixed teeth 142 of die cast cover 130. This will allow users to remove and terminate single pair ethernet cable 118 to single pair ethernet plug assembly 110 multiple times if necessary. Latches 146 on support legs 134 of strain relief clip 132 are designed to catch on ledges 148 of die cast cover 130 to prevent removal of strain relief clip 132 from cover assembly 16 once strain relief clip 132 has been secured in place. As part of cover assembly 116; strain relief clip 132 allows for a range of cable sizes between 118 AWG and 123 AWG with sufficient cable retention.

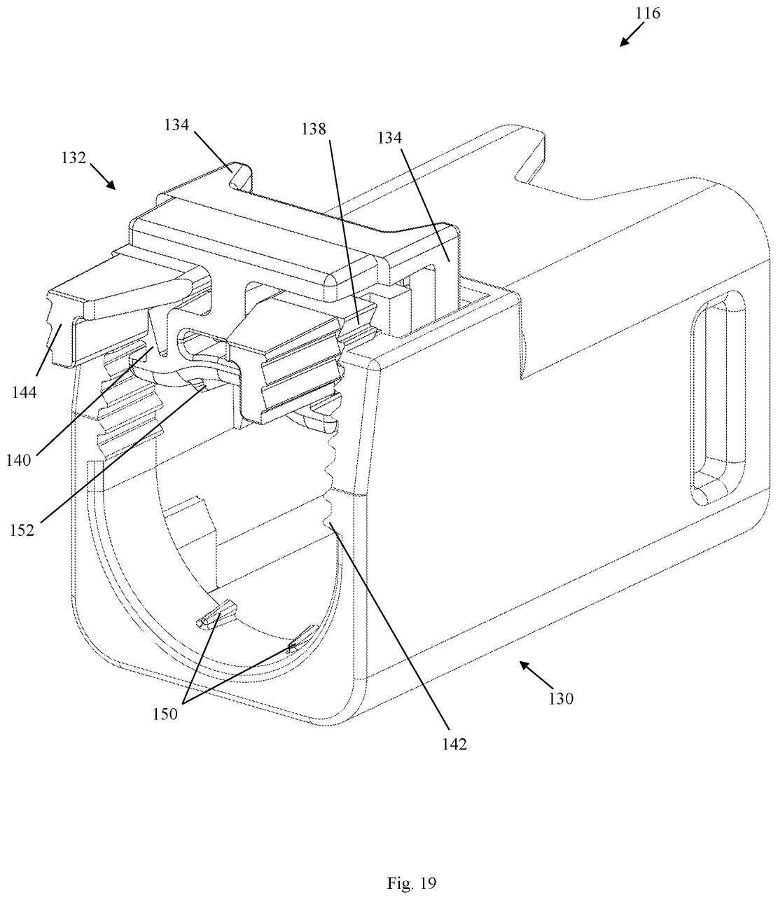

FIG. 19 is a rear isometric view of cover assembly 16 with strain relief clip 132 in a fully open position.

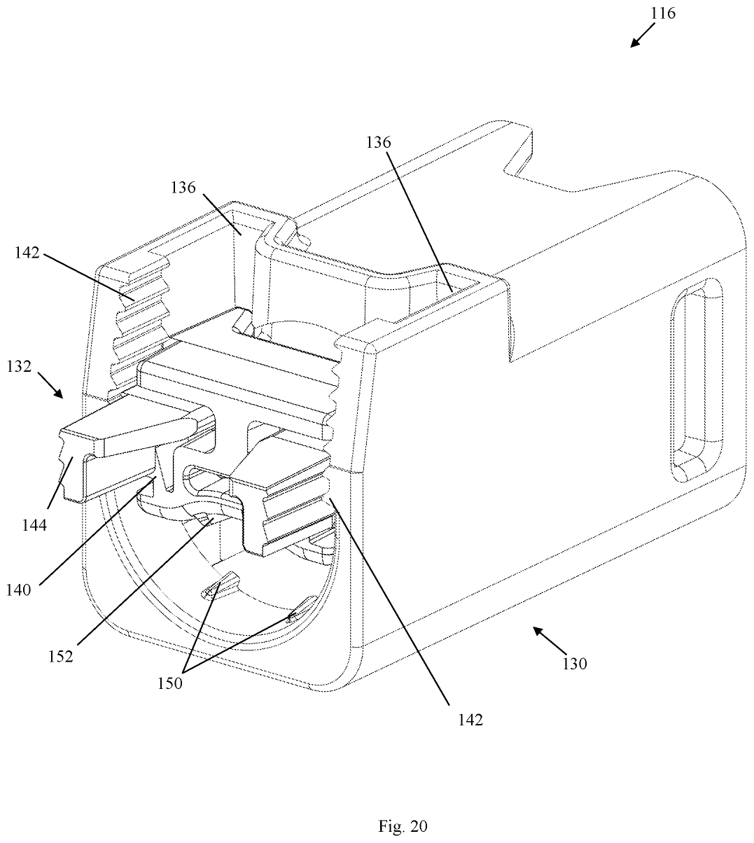

FIG. 20 is a rear isometric view of cover assembly 16 with strain relief clip 132 in a fully closed position.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A communication connector comprising:
a cover body with an opening; and
a strain relief clip having an opening configured to accept a communications cable and to be partially inserted into the opening, the strain relief clip having a plurality of grip arms configured to extend into the opening and surround an inserted cable and further configured to interact with an inside wall of the cover body such that rotation of the strain relief clip relative to the cover body causes the grip arms to press against the inserted cable.

2. The communications cable of claim 1 wherein the strain relief clip is configured to have a ratcheting relationship with the cover body.

3. The communications cable of claim 1 wherein the cover body is composed of die cast metal.
